(19) United States
(12) Patent Application Publication
(10) Pub. No.: US 2004/0033018 A1
(43) Pub. Date: Feb. 19, 2004

(54) Grating apodisation method and apparatus

(76) Inventors: Michael Kevan Durkin, Hampshire (GB); Mikhail Nickolaos Zervas, Hampshire (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/343,994

(22) PCT Filed: Jun. 29, 2001
(86) PCT No.: PCT/GB01/02893

(30) Foreign Application Priority Data
Aug. 7, 2000 (EP) 00306707.1

(51) Int. Cl. G02B 6/34

(52) U.S. Cl. 385/37

(57) ABSTRACT

A method and apparatus for writing an apodised grating of improved quality into a photosensitive material using an interference pattern of fringe period [symbol] _{gr}. An unapodised part of the grating is written by exposing the photosensitive material with a succession of exposures separated from each other by an odd number of fringe periods and an apodised part of the grating is written by exposing the photosensitive material with a first set of N exposures, where N is an even number, separated from each other by an odd number of fringe periods, the first set of N exposures having a positive phase offset +φ relative to the unapodised part of the grating and exposing the photosensitive material with a second set of N exposures separated from each other by an odd number of fringe periods, the second set of N exposures having a negative phase offset −φ relative to the unapodised part of the grating.

### BACKGROUND OF THE INVENTION

The invention relates to a method of writing apodised gratings and an apparatus for writing apodised gratings.

WO 98/08120 discloses a method of and apparatus for writing gratings in photosensitive material, such as photosensitive optical fibre. This method is now in widespread use. The basis of the method is repeatedly exposing the photosensitive material through a phase mask of period [symbol] ₚₘ with an interference pattern of fringe period [symbol] _{gr}=Λₚₘ/2, the interference pattern being moved on by one fringe period between each exposure. The grating is thus built up by a large number of exposures, each offset from each other by one fringe period.

This method has proven highly successful for writing high quality gratings in photosensitive optical fibres. It can be applied to fabrication of chirped or unchirped gratings.

If apodisation is required, the method is adapted by changing the step between each exposure to a fraction of the fringe period. This is described in WO 98/08120. To cause complete extinction of the grating, i.e. full apodisation, a phase shift of ±π/2(± [symbol] ₚₘ/4) is provided between successive exposures.

This apodisation technique has been successfully implemented and is routinely used. The apodised gratings fabricated using this method are among the highest quality currently available.

### SUMMARY OF THE INVENTION

According to the invention apodisation is achieved with two or more sets of exposures, each set comprising at least two exposures separated from each other by an integer odd number of grating periods, and the sets being offset relative to each other by a fraction of the grating fringe period. In the simplest embodiment, there are two sets of exposures, each set comprising a pair of exposures. Each pair of exposures is separated by a single grating fringe, and dephasing is introduced between the pairs of exposures.

It will thus be appreciated that, with the invention, dephasing is introduced between sets of multiple exposures. This contrasts with the prior art in which dephasing is introduced between individual exposures. In this way, interference pattern components not having the desired fundamental periodicity can be cancelled out.

The basis for the invention is experimental and theoretical studies by the inventors, described in detail below, through which it has been discovered that the basic method of grating writing according to WO 98/08120 does not proceed as previously thought. This new understanding of how the method of WO 98/08120 provides an understanding of why the gratings fabricated using the method are of such high quality. However, the high quality does not arise from the reasons previously thought.

Previously it was thought that the high quality arose principally from averaging out of defects in the phase mask fabrication as a result of each part of the grating being written with a large number of individual exposures made at different positions of the phase mask.

Although this is still believed to be true, it has been discovered that an additional major factor in the success of the method is its effective cancellation of zeroth order diffraction contributions from the phase mask. Moreover, it has been discovered that this only occurs when each exposure is separated by a single fringe period (or a higher odd number of fringe periods). In practice, the method of WO 98/08120 has always been implemented with a single fringe period step as this is most convenient. Consequently, although not appreciated, the advantageous cancellation of the zeroth order diffraction contributions was inherent in how the prior art technique was implemented in practice, thus accounting for the high quality of the gratings produced thereby. Further, in the prior art, it was not appreciated that carrying out the method of WO 98/08120 with two, or other even number of, fringe period steps between exposures would not have produced such good results.

Further, based upon the new found understanding of the importance of, and nature of, the zeroth order diffraction contributions, it has been realised that the prior art method for writing apodised grating regions was imperfect, as detailed below. The prior art apodisation method is imperfect, because the zeroth order contributions only cancel out if each exposure is separated by a fall fringe period (or higher odd multiple thereof), which is of course not the case du prior art apodisation, in which the exposure separation is deliberately set to a fraction of a full fringe period.

The invention was made to address this newly discovered problem with the existing apodisation technique.

In addition it is noted that the reduced contrast resulting from this flaw in the prior art apodisation method does not limit the performance of apodised gratings in typical current gratings, where other factors still dominate grating quality. Consequently, without the new found understanding of the effects of the zeroth order diffraction contribution, there would have been no motivation to seek an alternative apodisation method.

Test grating structures have been fabricated to verify the improved quality of the new apodisation method of two embodiments of the invention in comparison to the prior art apodisation method. The results from these test structures show a major improvement in apodisation quality for both tested embodiments.

The new apodisation method is expected to be of particular use for fabricating narrow band gratings for use in 40 Gb/s or higher speed wavelength division multiplexed (WDM) transmission systems.

According to one aspect of the invention there is provided a method of writing a grating into a photosensitive material using an interference pattern of fringe period [symbol] _{gr}. The unapodised part of the grating is written conventionally. The apodised part or parts of the gating are then each written by:

(i) exposing the photosensitive material with a first set of N exposures separated from each other by an odd integer multiple of the fringe period, wherein N is an even integer equal to or greater than 2; and

(ii) exposing the photosensitive material with a second set of N exposures separated from each other by an odd integer multiple of the fringe period and offset from the first set of N exposures by a fraction of the fringe period to introduce dephasing.

Here it will be understood that the offset fraction will normally be less than one since this is convenient, but could be an improper fraction, i.e. a fraction of more than one, since there is no physical difference between, for example, a ¼ period phase shift and a 5/4 period phase shi.

Alternatively, the method may be defined by:

(a) writing an unapodised part of the grating by exposing the photosensitive material with a succession of exposures separated from each other by an odd number of fringe periods; and

(b) writing an apodised part of the grating by:

(i) exposing the photosensitive material with a first set of N exposures, where N is an even number, separated from each other by an odd number of fringe periods, the first set of N exposures having a positive phase offset ±φ relative to the unapodised part of the grating; and

(ii) exposing the photosensitive material with a second set of N exposures separated from each other by an odd number of fringe periods, the second set of N exposures having a negative phase offset −φ relative to the unapodised part of the grating.

In one embodiment N=2 to provide pairs of exposures with the dephasing being introduced between the pairs. In another embodiment N=4 to provide sets of four exposures with the dephasing being introduced between the sets of four exposures. Higher even values of N may also be used, e.g. N=6 or N=8, to suppress higher order effects.

To provide a desired apodisation profile, a plurality of first and second sets of exposures are performed along the photosensitive material, with the respective offsets being varied. For example, the respective offsets can be varied along the photosensitive material from a small fraction towards a fraction of one-half at which maximum extinction is achieved, thereby to progress smoothly from no apodisation at the end of the unapodised part of the grating to full apodisation at the end of the grating structure.

The interference pattern may be generated with an interference pattern generator that is moved relative to the photosensitive material between the exposures. The interference pattern generator will typically be a phase mask, but in principle an interferometer could be used instead.

The photosensitive material into which the grating is written may be optical fibre, planar waveguide, or any other suitable photosensitive material which may not even form part of a waveguide.

It will be understood that a further aspect of the invention is an apodised grating fabricated using any of the above described methods. Typically, the grating will of course be apodised at both ends.

A further aspect of the invention is provided by an apparatus for writing a grating, comprising:

a positioner for moving a photosensitive material relative to an interference pattern generator;

a light source arranged to illuminate the interference pattern generator and generate an interference pattern of fringe period [symbol] _{gr} on the photosensitive material; and

a controller arranged to generate exposures of the interference pattern onto the photosensitive material at positions defined by the positioner.

The controller is operable to write a desired apodisation profile by:

generating a first set of N exposures separated from each other by an odd integer multiple of the fringe period, wherein N is an even integer equal to or greater than 2; and

generating a second set of N exposures separated from each other by an odd integer multiple of the fringe period and offset from the first set of N exposures by a fraction of the fringe period to introduce dephasing.

Alternatively, the apparatus controller may be defined as being operable to:

(a) write an unapodised part of the grating by exposing the photosensitive material with a succession of exposures separated from each other by an odd number of fringe periods; and

(b) write an apodised part of the grating by:

(i) exposing the photosensitive material with a first set of N exposures, where N is an even number, separated from each other by an odd number of fringe periods, the first set of N exposures having a positive phase offset +φ relative to the unapodised part of the grating; and

(ii) exposing the photosensitive material with a second set of N exposures separated from each other by an odd number of fringe periods, the second set of N exposures having a negative phase offset −φ relative to the unapodised part of the grating.

The controller may advantageously be operable to allow several different values of N to be externally selected, e.g. N=2, 4, 6, 8 . . . etc.

### BRIEF DESCRIPTION OF TIM DRAWINGS

For a better understanding of the invention and to show how the same may be carried into effect reference is now made by way of example to the accompanying drawings in which:

FIG. 1 is a schematic diagram of a UV-probing interrogation technique developed for studying optical fibre gratings fabricated with various different techniques;

FIG. 2 is a graph showing intensity I of luminescence (fluorescence) in arbitrary units as a function of relative position z in microns along a grating fabricated by a simple prior art phase mask exposure;

FIG. 3 is a graph showing fringe intensity I in arbitrary units as a function of relative position z in microns along a grating—calculated data is shown with the dashed line, experimental data points are shown with individual dots and a 5-point sliding average of the experimental data is shown with the solid line;

FIG. 4A shows a number of loss pattern curves averaged over 2 microns (plotted as intensity I in arbitrary units) against relative position z in microns along respective gratings made by phase mask exposures at different phase-mask-to-fibre separation distances varied from 50 microns (top curve) to 950 microns (bottom curve);

FIG. 4B is a graph corresponding to FIG. 4A but of calculated data obtained from a three-beam interference model averaged over 2 microns in the direction normal to the phase mask, the ratio of the zeroth order to ±1st order diffraction skis being varied in each calculated curve to fit the corresponding experimental curve of FIG. 4A—the results show that the diffraction efficiency into the fist orders varies from 2% (top curve corresponding to 50 micron phase-mask-to-fibre separation) to 40% (bottom curve corresponding to 950 micron phase-mask-to-fibre separation);

FIG. 5 is a graph showing calculated inferred refractive index change Δn against relative position z in microns for a first single exposure (E1—faint solid line) a second single exposure (E2—dashed line) offset from the first exposure by one fringe period and the resultant after superposition of the first and second exposures (Σ/2—bold solid line), the resultant being divided by two for ease of representation;

FIG. 6 is a graph of the detected fringe amplitude A (inverted fringe intensity) versus relative position z in microns of a grating formed by the continuous grating fabrication technique of WO 98/08120 in which exposures are separated by a single gating period, the data being obtained by scanning the grating with a UV interference pattern;

FIG. 7 corresponds to FIG. 6 but for a grating fabricated by separating the exposures by two grating periods instead of one;

FIG. 8 has axes corresponding to FIG. 5 and is representative of conventional apodisation for the method of WO 98/08120 in which a first single exposure (E1—faint solid line) is made followed by a second single exposure (E2—dashed line) offset from the first exposure by a fraction of the fringe period (one half here for full π dephasing) and the resultant from the superposition of the first and second exposures (Σ—bold solid line);

FIGS. 9A, 9B & 9C show fringe intensity I in arbitrary units against relative position z in microns for apodisation performed according to the prior art for: no dephasing, i.e. no apodisation (FIG. 9A); π/2 dephasing, i.e. partial apodisation (FIG. 9B) and π dephasing, i.e. full apodisation (FIG. 9C).

FIGS. 10A, 10B and 10C show schematically apodisation according to: the prior art FIG. 10A); a first embodiment of the invention (FIG. 10B); and a second embodiment of the invention (FIG. 10C), where the rising-slope shading indicates a positive offset +φ of π/2 and the falling-slope shading indicates a negative offset −φ of π/2, where +φ is the offset relative to the extrapolated grating period of the unapodised part of the grating shown by vertical dashed lines;

FIGS. 11A, 11B & 11C are comparable to FIGS. 9A, 9B and 9C, showing fringe intensity I in arbitrary units against relative position z in microns for apodisation performed according to a first embodiment of the invention for: no dephasing, i.e. no apodisation (FIG. 11A); π/2 dephasing, i.e. partial apodisation (FIG. 11B) and π dephasing i.e. fill apodisation (FIG. 11C);

FIG. 12 shows reflectivity R in dB against wavelength λ in nm for three test structures each in the form of a grating fully adopised along its entire length, one of the test structures being fabricated with prior at apodisation (curve C0), another with apodisation according to the first embodiment (curve C1) and another with apodisation according to the second embodiment (curve C2);

FIG. 13 is a graph of reflectivity λ in dB against wavelength I in nm of the calculated effect of incomplete apodisation on the suppression of reflection side-lobes of an unchirped grating designed for 50 GHz grid spacing with a transmission loss of −30 dB;

FIG. 14 shows an apparatus for fabricating an apodised grating according to embodiments of the invention;

FIG. 15 shows the apparatus of FIG. 14 in more detail; and

FIG. 16 shows internal structure of the controller of the apparatus of FIGS. 14 and 15.

### DETAILED DESCRIPTION

1. Novel Interrogation Technique for Measuring Grating Fringes

A novel technique is now described that is been especially developed to allow resolution of grating fringes. The method is based on monitoring the level of fluorescence seen when a grating structure is scanned with a low-power UV interference pattern, and may be considered to be a development of the method described in EP-A-0878721. Reference to the related technique of EP-A-0843186 is also made. The present technique is capable of resolving both the large and small-scale structure of fibre Bragg gratings (FBGs) by probing the bleaching pattern of a fluorescence mechanism associated with the UV-induced formation of gratings in photosensitive fibre.

It is known that the exposure of a germano-silicate glass to ultraviolet (UV) light results in fluorescent emission at a wavelet of −400 nm. It is observed that the level of this fluorescence falls with prolonged exposure. This is caused both by a bleaching of the fluorescence mechanism, and by an increase in loss at short wavelengths caused by the photo-induced refractive index change. A consequence of FBG fabrication by UV exposure is thus a periodic bleaching/loss effect associated with the induced refractive index pattern. By interrogating the loss pattern, it is possible to gain insight into the structure of a FBG on a microscopic level.

The level of detected fluorescence fiber a given UV fluence on a fibre is (inconveniently) influenced strongly both by the material composition of the photosensitive glass, and by the guiding structure of the fibre. Of particular importance is the fact that the process of D₂ (or H₂) loading of the fibre (in order to increase the levels of photosensitivity) leads to a huge loss at the wavelength of guided fluorescence. This makes it very difficult to resolve fine details (such as grating fringes) of a photo-induced structure by the UV probe-beam approach. Conversely, fibres with a boron co-doped core exhibit very high levels of fluorescence, even on re-exposure, while allowing strong refractive index features to be induced without the need for D₂ loading. For these reasons, a boron co-doped fibre with an NA of 0.13 was used for the purposes of the following series of experiments.

The principle of the technique is to scan a grating with a UV probe beam and to monitor the level of guided fluorescence. A trial of the method was made with a long-period grating structure. The grating had a period of 500 μm and was formed by a pulsed UV beam focused to a waist of ˜250 μm. The structure could be clearly seen by monitoring the level of guided fluorescence on scanning the structure with a lower power UV beam. It was ascertained that beam powers of −5 mW result in levels of fluorescence sufficient to be detected, while not significantly modifying the refractive index structure.

The experimental arrangement for interrogating short-period FBGs is somewhat different, since the spatial period of the refractive index structure (typically ˜530 nm for gratings with a response in the EDFA bandwidth) is significantly smaller than the spot size that can be achieved without significant rearrangements of the optics used to inscribe the grating. The extension of this technique to FBGs thus requires the fabricated grating to be scanned with a interferometrically-generated interference pattern with a fringe separation closely matched to the period of the grating. There is no practical difficulty in achieving this criterion, since the method for generating the UV fringes used to fabricate the grating provides an ideal UV footprint for subsequent interrogation of its structure. An important point to observe is that the system used to monitor the oscillations of the fluorescence during the interrogation must have a bandwidth/sample-rate sufficient to easily resolve the ˜530 nm structure of the grating when it is scanned through the UV interference pattern (i.e.>>2 kHz for a scan speed of 1 mm/s).

The detected fluorescence level can be considered as an auto-correlation function of the intensity pattern in the case where the interference fringes and the induced-loss have the same form (as may be expected for a stationary phase mask exposure). The auto-correlation of a function comprising several oscillatory components is itself dominated by these components. The information of the phase relation between the oscillatory components, however, is not retained in the auto-correlation. In the case where the induced loss pattern and the probe pattern are different, however, the detected fluorescence pattern is a cross-correlation,

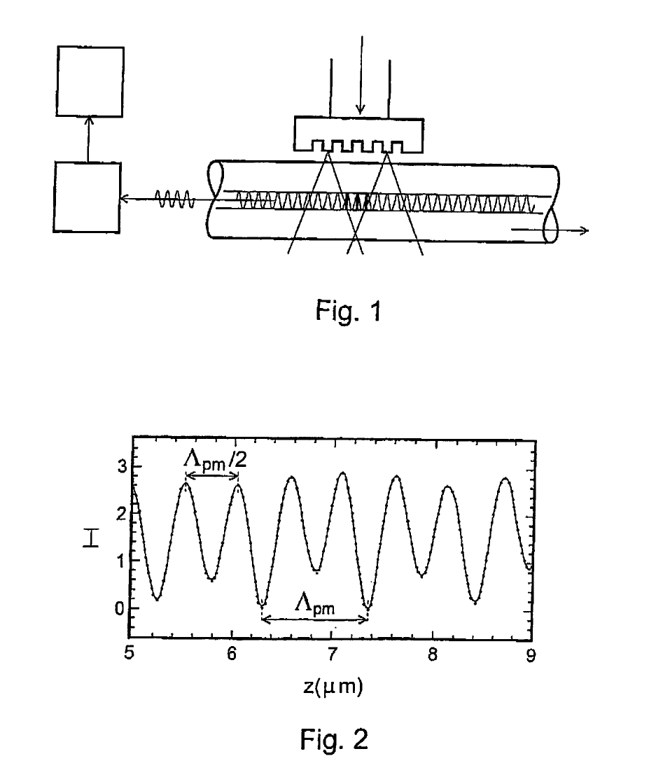

FIG. 1 shows schematically the experimental arrangement used for implementing the above-described technique of interrogating the loss pattern associated with the induced refractive index structure.

The system used was based around a silicon photodetector with a bandwidth of 10 kHz and a 16-bit PCI A/D data-acquisition card with a m um sample rate of 100 kHz. The system can be used to extend the functionality of any grating fabrication system without any optical rearrangement. A 244 nm FreD laser was the WV source for both grating inscription and interrogation. The beam was passed through an acousto-optic modulator (AOM) and the first diffracted order was used as the probe beam in order that its power may be readily controlled. Typically the probe beam had a power of ˜5 mW and the fibre was scanned with a velocity of 250 μm/s giving detected fluorescence levels of −45 dBm to −50 dBm. The periodic intensity pattern was generated by the same phase mask used to fabricate the grating. The grating can be interrogated without removal from the fabrication system.

There are two main experimental points to be noted.

First, the detector used must have sufficient bandwidth to detect passing grating fringes. However, this leads to a reduction in the maximum gain available (for a certain gain-bandwidth product) which can make it difficult to apply this technique to fibre where the photo-induced loss is large. The grating fringes induced in the boron co-doped fibre used in this series of experiments were visible as a peak-to-peak voltage change of ˜10 mV at the output of the detector for a 5 mW UV probe beam. For other types of fibres this signal is much less and it would be required to use phase-locked amplification methods to resolve the signal from noise.

Second, in order to realise a dynamic range approaching the full 96 dB offered by the 16-bit DAC, it is important that a continuous cable screen be used between the output of the A/D card and the detector. Earth loops also present a problem for signals of this level, so care must be taken to avoid this possibility.

Direct memory access (DMA) and double-buffering data acquisition techniques were used to allow other computational processes to be active while data is collected (timing jitter may otherwise be a problem). This is extremely useful since real-time display of data during acquisition is helpful to the user. A multi-threaded windows-based program was written in C++ to concurrently collect and display data.

The main advances of this grating interrogation technique are considered to be:

(i) straightforward application to any grating fabrication system without requiring any change in optical configuration;

(ii) resolution of microscopic features, rather than just the average level of refractive index change;

(iii) increased sensitivity compared to free-space detection methods;

(iv) fast rate of data collection; and

(v) (indirect) detection of features associated with small refractive index changes.

On the other hand, the main limitations of the grating interrogation technique are considered to be:

(i) the features detected are the average of all the features encompassed in the width of the probe beam;

(ii) compatibility problems with D₂ loaded fibres; and

(iii) no direct measurement of induced refractive index.

2. Studies of Gratings Formed by Single Phase Mask Exposure

Most commonly used techniques for fabrication FBGs involve illumination through a phase mask to generate an interference pattern. With tis in mind, a series of experiments was performed to investigate the properties of FBGs formed by the simplest kind of phase mask writing technique, namely gratings written by a single exposure of a fibre through a static phase mask.

In the first of the experiments, gratings were induced in a length of fibre by making a stationary UV exposure trough a π phase mask having a quoted zeroth-order suppression of <5% (not by any means ideal). The UV beam power was ˜30 mW on the fibre and the exposure time was five seconds. The induced grating structure was then scanned past the UV probe-beam interference pattern (˜5 mw) at a rate of 250 μm/s.

FIG. 2 shows data collected from the experiments. There is a high signal-to-noise ratio and the 16-bit DAC gives a good resolution. (It is also noted that it is possible to take readings on a nanometre scale, if desired). The main causes of noise are fluctuations in the laser output power and possible vibrations of the fibre. The effect of laser output noise could be eliminated by using a differential detection technique, whereby the laser power is sampled concurrently with the fluorescence to give a reference. It is noted that, since increasing loss corresponds to increasing refractive index, the refractive index pattern of the grating is inverted with respect to the fringe intensity shown.

In FIG. 2, the fringe pattern is clearly representative of the grating's refractive index structure, since the dominant period is half that of the phase mask (˜530 nm). As well as the fundamental grating period [symbol] _{gr}, a strong sub-harmonic component is apparent at the period of the phase mask [symbol] ₚₘ=2 [symbol] _{gr}. In all previous studies of grating writing using phase mask technology and grating characterisation, it has been assumed that the imprinted refractive index variations are sinusoidal with a period [symbol] _{gr} half that of the phase mask [symbol] ₚₘ, that is [symbol] _{gr}=0.5 [symbol] ₚₘ. From the results of FIG. 2, it appears that this assumption was not a good one.

The results can be explained in terms of a three beam interference pattern involving not only the ±1st diffracted orders, but also the zeroth diffracted order. The grating (and the interrogation measurements) are effectively the result of the phase mask interference pattern integrated over the extent of the fibre core (assuming a cylindrical geometry). The size of the fibre core is not known exactly, but is assumed to be 5 μm. This value is smaller than the 9 μm fluctuation period of the interference pattern, so even integration over the full depth of the core is not sufficient to result in an averaged refractive index pattern that is solely periodic at half the phase mask period. The interference pattern for a phase mask of period 1066 nm, with a zeroth-order component of 5%, and diffraction efficiency of 40% into the ±1st orders was calculated and integrated over a 5 μm cylinder in the z-direction (corresponding to the approximate size of the fibre core) at a distance of 100 μm from the phase mask.

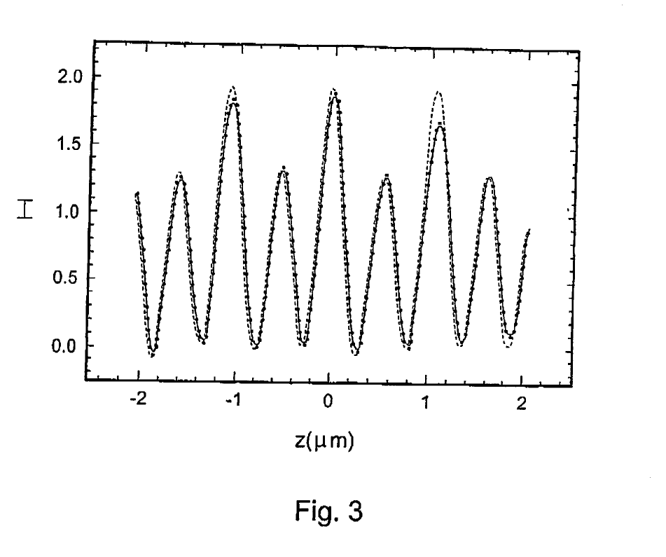

FIG. 3 shows data calculated according to this theoretical model (dashed line) compared to an inverted version of the experimental data shown in FIG. 2 (solid line). There is clear agreement between the observed loss pattern associated with the grating (experiment) and the expected interference pattern of the phase mask (theory).

Importantly, these results also confirm that the association of the UV-probed loss pattern to the refractive index pattern of the grating (and the interference pattern of the phase mask) can be made with a high degree of confidence.

Further experiments were then carried out to appraise the effect of fibre-to-phase mask separation. A series of gratings were made, under the same conditions as specified above, with different fibre-to-phase mask separations, varying from 50 μm to 950 μm.

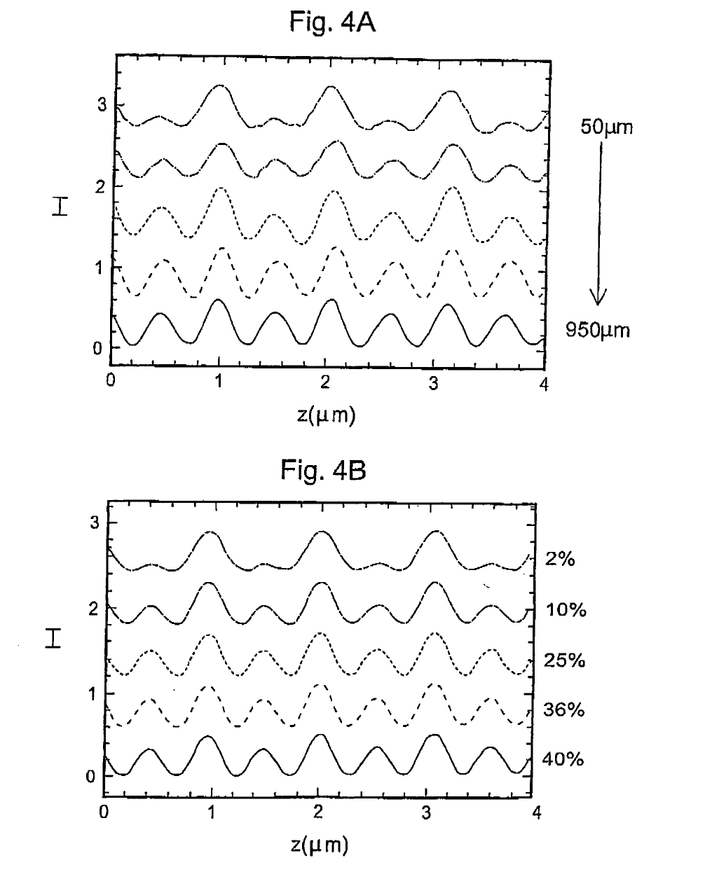

FIG. 4A shows the results of interrogating each of the series of gratings with a UV probe beam. It is noted that the fringe depths have been normalised in the figure. It is clear that the ratio of the component with the desired grating period (half that of the phase mask) to the subharmonic component (equal to that of the phase mask period) increases as the phase mask is withdrawn from the fibre. In other words, grating quality improves with increasing phase-mask-to-fibre separation.

FIG. 4B shows data calculated from a model developed to understand the results of FIG. 4A. The model was based on the hypothesis, i.e. assumption, that the results could be explained as the average across the beam diameter of an interference pattern with an effective first-order diffraction efficiency that decreases linearly with distance from the phase mask. The model integrates over a 5 μm cylinder, as before, to simulate the core effect. The data of the 950 μm separation distance fits well with the theoretical results of a 40% diffraction efficiency into the ±1st orders and 5% into the zeroth order (as in FIG. 3). The data acquired with a separation of 50 μm were found to fit the theory well for an effective diffraction efficiency into the ±1st orders of 2%. For intermediate separations between 50 μm and 950 μm, the effective diffraction efficiency was calculated from a linear regression through these two end points.

A comparison of FIG. 4A and FIG. 4B shows that the theory accurately reproduces the experimental results. It is thus clear that the desired first order contribution becomes stronger as the phase mask is moved away from the fibre and that there is a significant contribution from the zeroth order for all separation distances. Moreover, the zeroth order contribution becomes stronger, and eventually dominates the first order contribution, as the phase mask moves closer to the fibre.

It is important to note that the fibre-to-phase-mask separation was the same for both grating formation and subsequent interrogation, resulting in an auto-correlation of the UV intensity pattern with the loss fringes. Had the separation changed, the results would represent a cross-correlation between the loss fringes formed by an interference pattern at one separation with the UV intensity pattern at another.

3. Studies of Gratings Formed by Fabrication Technique of WO 98/08120

From the above studies of gratings written by a simple prior art phase mask technique, it has been established that the fluorescence probing technique developed to probe the loss structure of FBGs works well, in that it gives a good representation of the induced refractive index pattern written into a fibre.

The main aim of developing the above-described fluorescence probing technique was however to investigate grating structures formed by the continuous grating fabrication technique of WO 98/08120, and the results of such investigations are now described.

The continuous grating fabrication technique of WO 98/08120 forms gratings by multiple exposures, each separated from each other by one or more grating periods. In practice, spacings of one grating period have been used, as this is most convenient. Every local part in the main body of the grating is thus formed by a large number of individual exposures, each offset by one grating period. This is achieved in practice by moving a phase mask, relative to the fibre, by a distance of one grating period between exposures.

By contrast, an alternative technique (EP-A-0 843 186) exposes a first section of fibre through a phase mask in one exposure and then uses the same, or another, phase mask to expose a second section of the fibre adjacent to the first section with only a very mall overlap at the end of the first section.

It is clear from the above investigations of gratings written with a simple phase mask technique that the interference pattern of a phase mask has a significant subharmonic component as a consequence of the (inevitable) presence of finite power in the zeroth diffracted order.

On the other hand, a grating formed according to the technique of WO 98/08120 in which multiple exposures are separated by a single grating period should be free of this problem, because the sub-harmonic components arising from successive exposures should cancel out.

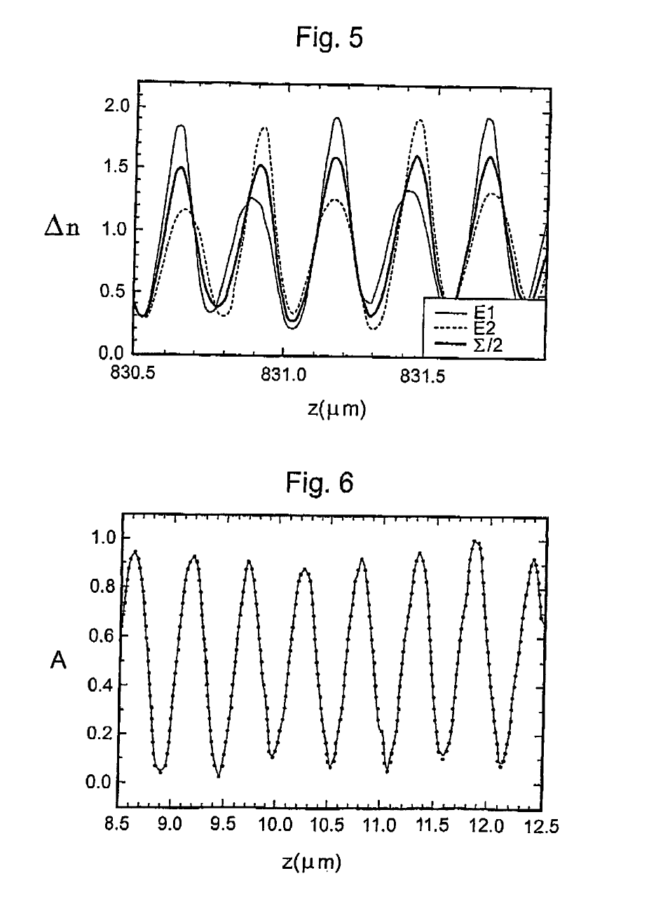

To simulate this situation, data of the measured loss pattern from a single exposure (shown in FIG. 3) were used to calculate the expected refractive index pattern from two such exposures separated by one grating period (533 nm in this case). FIG. 5 shows the calculated results in terms of the calculated inferred refractive index change Δn as a function of relative position z in microns along the grating. The profile for a first single exposure is shown by curve E1 (faint solid line). The profile for a second single exposure offset from the first exposure by one fringe period is shown by curve E2 (dashed line). The normalised resultant after superposition of the first and second exposures is shown by curve Σ/2 (bold solid line). Strikingly, and as predicted, the resultant refractive index pattern of curve Σ/2 is almost completely free of the subharmonic component that is strongly present in the refractive index profiles produced from single exposures.

FIG. 6 shows the fringe pattern detected by scanning a structure made by the continuous grating fabrication technique of WO 98/08120 with the grating being formed by multiple exposures, each separated by a single grating period. The pattern closely resembles that predicted (see FIG. 5) and is much closer to the ideal sinusoidal refractive index pattern of gratings formed by simple phase mask scanning techniques (see FIG. 2). The intensity characteristics of FIG. 6 correspond to a cross-correlation between the UV interference pattern and the loss pattern associated with gratings formed with a predominantly single spatial period. The noise on the structure is more likely to be in the measurement than in the grating structure itself, since there is no multiple exposure averaging of noise in the measurement process.

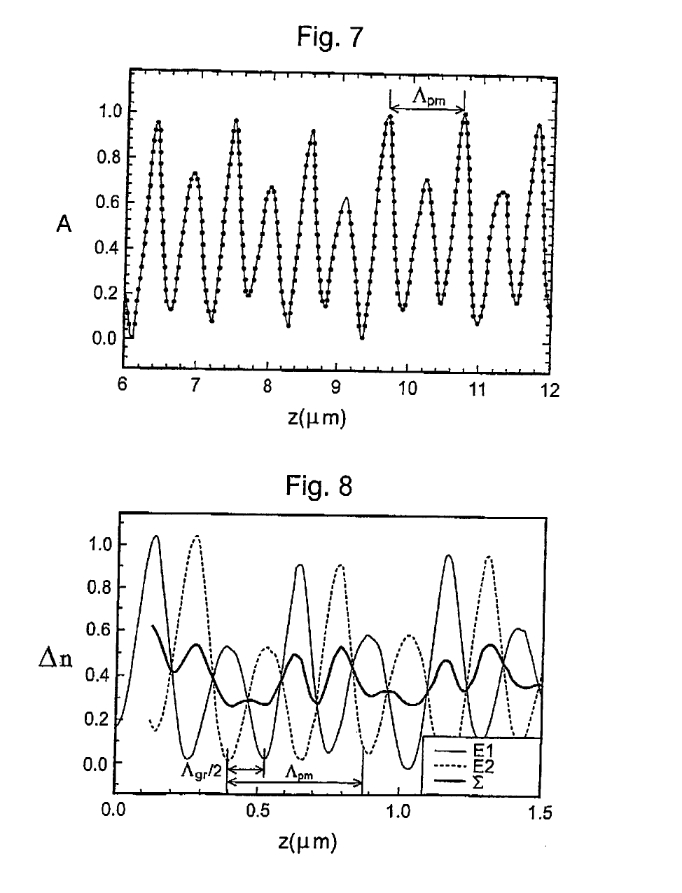

FIG. 7 shows the fringe pattern detected by scanning a structure made by the continuous grating fabrication technique of WO 98/08120 with the grating being formed by multiple exposures, each separated by two fringes, instead of one, to further test whether our interpretation is correct. The presence of a strong component with the period of the phase mask is seen, as expected (compare to FIG. 2 results, and contrast to FIG. 6 results). This result highlights the importance of the single fringe step between exposures when carrying out the continuous grating writing technique of WO 98108120. More generally, the results highlight the importance of moving by an integer odd number of fringe periods between exposures (as exemplified by FIG. 6) and not an integer even number of fringe periods between exposures (as exemplified by FIG. 7).

The original motivation for the approach taken with WO 98/08120 was to maximise the error reduction resulting from multiple exposures. In other words, it was considered that the multiple exposures would average out defects in the interference pattern, e.g. defects arising from local manufacturing flaws in the phase masks. However, the new results presented above indicate that the approach of WO 98/08120 also has the significant inherent benefit of automatically cancelling out contributions arising from interference between the zeroth order diffraction beam and each of the first order diffraction beams, provided that single (or other odd number) fringe steps are made between exposures. Perhaps slightly fortuitously, grating fabrication apparatus exploiting the method of WO 98/08120 have all designed to provide single fringe steps, thus inherently cancelling out the zeroth order effects.

4. Prior Art Apodisation Using Technique of WO 98/08120

Apodisation is conventionally achieved in the continuous grating fabrication technique of WO 98/08120 by dephasing alternate exposures. In other words, successive exposures are no longer separated by a single fringe period, as during the main body of the grating, but are instead separated by a fraction of a fringe period, with the size of the fraction (0 to ½) determining the degree of apodisation.

As previously mentioned, there has hitherto been an assumption that the refractive index pattern induced by a single exposure is of a sinusoidal form, or at least only has a single spatial-frequency component corresponding to the grating period. The results presented above have shown that this assumption is incorrect and that the interference pattern from a phase mask generally has a significant, sometimes dominant, sub-harmonic component. The effect of this on apodisation is now discussed.

Conventionally, to achieve full apodisation with the technique of WO 98/08120, two adjacent exposures are dephased by one-half of the grating period. The overall refractive index modulation should then be zero, provided that the interference pattern is sinusoidal, as previously assumed. However, when the interference pattern of an exposure is not sinusoidal, as has been shown to be the case, the overall refractive index modulation will not be zero, but rather will contain some remnant index modulation effect. The experimental data collected for a grating formed by a single exposure was used to assess this effect.

FIG. 8 shows the sum of two such exposures separated by half a grating fringe. Curve E1 represents a first single exposure (faint solid line). Curve E2 represents a second single exposure (dashed line) offset from the first exposure by one half of the fringe period for fill n dephasing. Curve Σ is the resultant from the superposition of the first and second exposures (bold solid line). It is clear from FIG. 8 that there is a significant limit to the minimum refractive index modulation that may be achieved with the prior art apodisation method.

An experimental investigation into the details of structures formed by the dephased-exposure apodisation technique was made by fabricating short gratings designed with a linear spatial variation of index modulation depth. These gratings were then interrogated with the UV probing technique to examine the microscopic effect of this apodisation method.

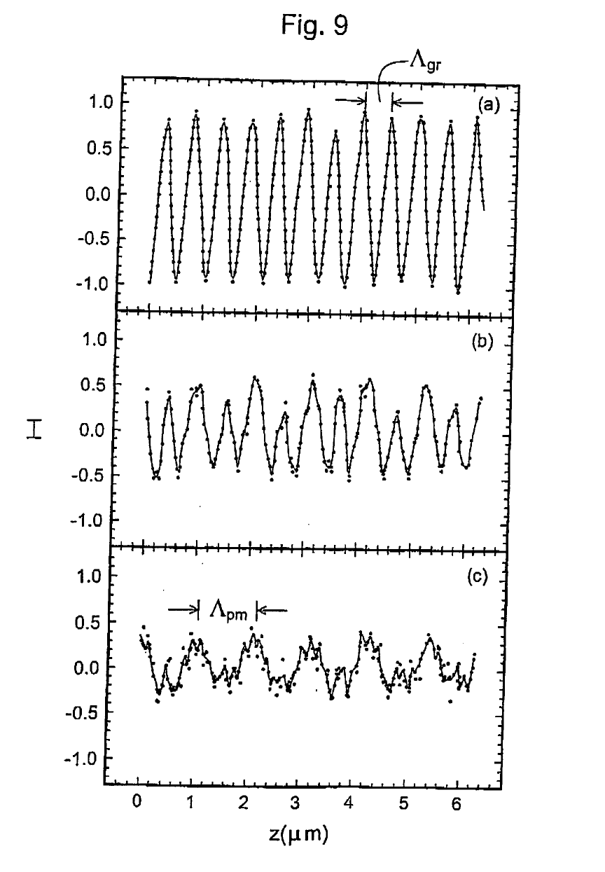

FIG. 9 shows the tinge intensity data at three points along such a grating (unapodised, partially apodised, almost fully-apodised). The unapodised section has a nearly sinusoidal form, as expected (FIG. 9A). As the level of apodisation is increased (FIG. 9B) the sub-harmonic spatial frequency becomes increasingly prominent. When the exposures are dephased by half a grating fringe (FIG. 9C) there is a strong attenuation of the fundamental grating period [symbol] _{gr}= [symbol] ₚₘ/2, but a relatively large component still remaining at the phase mask period [symbol] ₚₘ.

5. Apodisation According to Embodiments of the Invention

Having identified this inherent flaw in the prior art apodisation technique, two options were considered for improving the quality of apodisation using the continuous grating apodisation technique, namely:

(i) to determine the level of dephasing required for a given fringe depth at the grating period directly from the phase mask interference pattern; and

(ii) to ensure that the induced refractive index modulation is close to a sinusoidal form before it is dephased to achieve apodisation.

It was elected to pursue the second option, since a solution of this kind would have the advantage of being phase-mask generic, i.e. not specific to any particular phase mask.

Based on the above-described new insight into the microstructure of FBGs written with a variety of techniques, it was realised that the problem to be solved was how to cancel the interference effects originating from the zeroth order diffraction component during apodisation.

The chosen solution, of the first embodiment is simply to form an apodised grating by having two pairs of exposures, in which the pulses of each pair of exposures are separated by a single grating fringe, with dephasing introduced between the pairs of pulses, rater than between individual pulses, as in the prior art method.

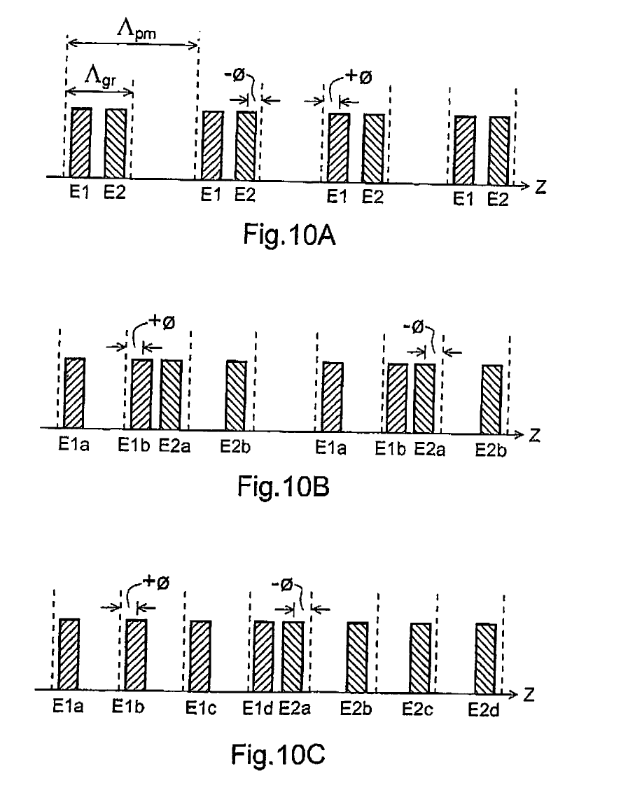

FIG. 10 shows his concept schematically. Shown are e prior art apodisation method (FIG. 10A), the solution described above (FIG. 10B—first embodiment), and an extension of this solution, based on dephasing a set of four grating exposures (FIG. 10C—second embodiment).

FIG. 10A shows the prior art apodisation method of WO 98/08120. A first exposure produces an interference pattern having peaks, i.e. pulses, which are labelled E1 in the figure, each separated by the phase mask period [symbol] ₚₘ=2 [symbol] _{gr}. A second exposure is then made which is dephased from the first exposure by a fraction of the grating period (1/n) [symbol] _{gr}. The pulses of the second exposure are indicated with bars labelled E2 in the figure. Each of the pulses of the second exposure are of course also separated by the phase mask period [symbol] ₚₘ=2 [symbol] _{gr}. This apodisation method suffers from artefacts from the zeroth diffracted order as discussed above.

FIG. 10B shows the apodisation method of the fist embodiment. The method is built up from sets of four exposures, instead of sets of two exposures as in the prior art method. The four exposures can be classified into two pairs of exposures. The first pair of exposures is labelled E1a and E1b in the figure. The second pair of exposures is labelled E2a and E2b in the figure. The exposures of the first pair are separated by the grating period [symbol] _{gr}. This ensures that the two exposures of the first pair of exposures collectively produce a refractive index profile in which sub-harmonic components having the phase mask period [symbol] ₚₘ=2 [symbol] _{gr} are cancelled out, thus cancelling out the undesirable effects of interference between the zeroth order diffraction and each of the fist order diffractions. The exposures of the second pair are also separated by the grating period [symbol] _{gr}, ensuring that the two exposures of the second pair of exposures also collectively produce a refractive index profile in which the zeroth order effects are cancelled out. Apodisation is then controlled by the degree of offset between the first pair of exposures and the second pair of exposures. This may be viewed as the offset between pulses E1a & E2a, or E1b & E2a, or indeed between the mid-points between E1a & E1b on the one hand and E2a & E2b on the other hand.

FIG. 10C shows the apodisation method of the second embodiment. The method is built up from sets of eight exposures, instead of sets of four exposures as in the first embodiment. The eight exposures can be classified into two groups of four exposures. The first group of four exposures is labelled E1a-E1d in the figure. The second group of four exposures is labelled E2a-E2d in the figure. Apodisation is controlled by the degree of offset between the first group of exposures and the second group of exposures. Each of the four exposures of the first group are separated from each other by the grating period [symbol] _{gr}. This cancels not only sub-harmonic components having the phase mask period, but also any sub-harmonic components having twice the phase mask period, such as components arising from the second diffracted orders.

It will be understood that in further embodiments, groups of N exposures where N is larger than 4 may be used to suppress still higher order components. However, N should not be an odd number, since then the problem with the prior art will reappear, since the zeroth order contribution will no longer be cancelled out.

In general, the best apodisation from a theoretical point of view will be achieved by using sets of N exposures, where the interference pattern of the phase mask has sub-harmonic components with periodicity up to N-times the period of the grating. For instance, if the small contributions of the ±2nd diffracted orders are considered, then there may be a further higher order sub-harmonic components to the interference pattern. For practical reasons, such as the finite size of the UV writing beam, it is considered, at least at present, to be best in practice to limit N to a value of two or four, as in the first and second embodiments.

The apodisation method is thus based around the period of the natural interference patter of the phase mask, rather than the interference pattern period of the first order diffractions from the phase mask, which is half the size.

The linearly-apodised grating experiment was repeated for the new apodisation technique of the first embodiment (i.e. N=2). As before, the structure was interrogated with the UV-probing method.

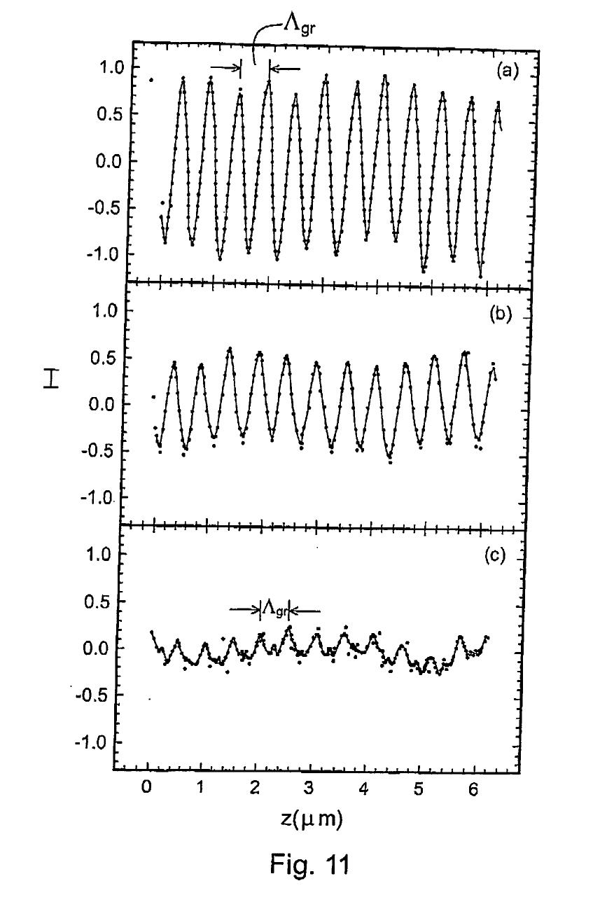

FIG. 11 shows the results from three sections of the grating with different degrees of apodisation. In comparison to FIG. 9, it is apparent that the apodisation technique of the first embodiment provides a refractive index pattern with virtually no sub-harmonic component (The longer scale drift probably results from slight fibre misalignment during measurement). Additionally, in comparison with the prior at apodisation technique, there is much higher extinction at full apodisation with one-half grating fringe offset (compare FIG. 9C with FIG. 11C).

In order to assess the fringe extinction achievable with various grating techniques, a series of test gang structures were made, which were designed to have complete apodised (π offset) along their full lengths. In theory, the test grating structure should then have no refractive index modulation. In other words, there should be no Bragg reflection whatsoever. The level of remnant Bragg reflection in the manufactured test structures is thus an inverse measure of goodness of the apodisation technique.

From previous experience, it is known that the basic apodisation technique, while not perfect, is certainly capable of generating very high-quality gratings. For this reason the gratings fabricated were 25 cm in length and unchirped. An unapodised uniform grating of this length would be very strong (>−60 dB transmission loss) so even very small levels of index contrast will lead to a readily-measurable spectral response.

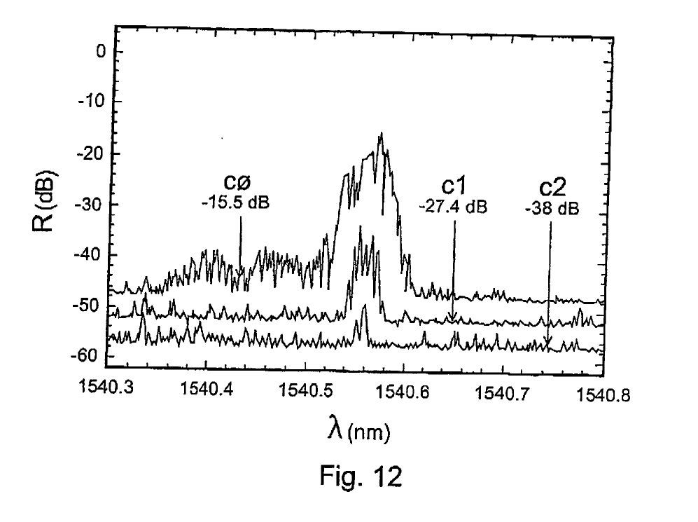

FIG. 12 shows spectral responses of the test grating structures fabricated with the apodisation methods of the prior art (Curve C0), the first embodiment (Curve C1) and the second embodiment (Curve C2) respectively. For ease of representation Curve C1 is shifted by −5 dB and Curve C2 is shifted by −10 dB.

With the prior art apodisation technique (Curve C0), the test grating struggle has a small Bragg reflection of approximately −15.5 dB (3%) in magnitude.

With the first embodiment apodisation technique (Curve C1) based on pair of pulses, the Bragg reflection strength falls to approximately −27.4 dB (0.25%).

With the second embodiment apodisation technique (Curve C2) based on sets of four pulses, the Bragg reflection strength falls still further to just −38 dB (0.016%).

The effective refractive index modulation depths are correspondingly: 3.3×10⁻⁶; 8×10⁻⁷; and 2.5×10⁻⁷.

The effective index depth for the prior art apodisation technique represents about 1% of the index change that would be induced in this fibre if the grating was unapodised.

Both the first and second embodiments thus result in major improvements in the apodisation quality, in comparison with the prior art technique.

The effect of a minimum fringe contrast level was evaluated numerically for the example of unchirped gratings designed for a 50 GHz grid with a transmission loss of −30 dB. In the example, the grating length is 20 mm, the effective refractive index modulation depth is 25×10⁻⁵, and a Blackman apodisation profile was used. The spectral characteristics were considered for ideal apodisation, for a minimum of 1% fringe contrast (corresponding to the prior art apodisation method), and a minimum of 0.25% fringe contrast (corresponding to that achieved with the fit embodiment using dephased pairs of exposures).

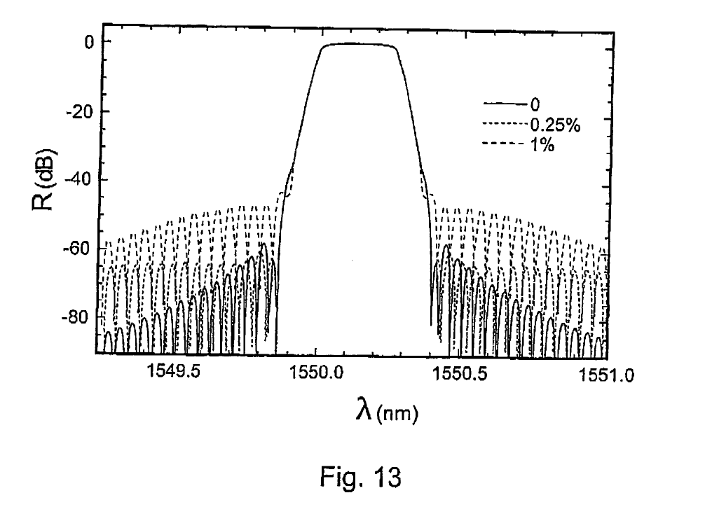

FIG. 13 shows the results. It is apparent that just 1% minimum fringe contrast is sufficient to compromise the reflection side-lobe suppression of such a grating by 10-15 dB. A noticeable improvement is seen when this level is 0.25%, corresponding to the first embodiment apodisation technique. While this effect is not currently the limiting factor in grating fabrication, it may be soon as other developments are made, so it is important that a route to improved apodisation has been identified for future use.

6. Apparatus for Fabricating Apodised Gratings Embodying the Invention

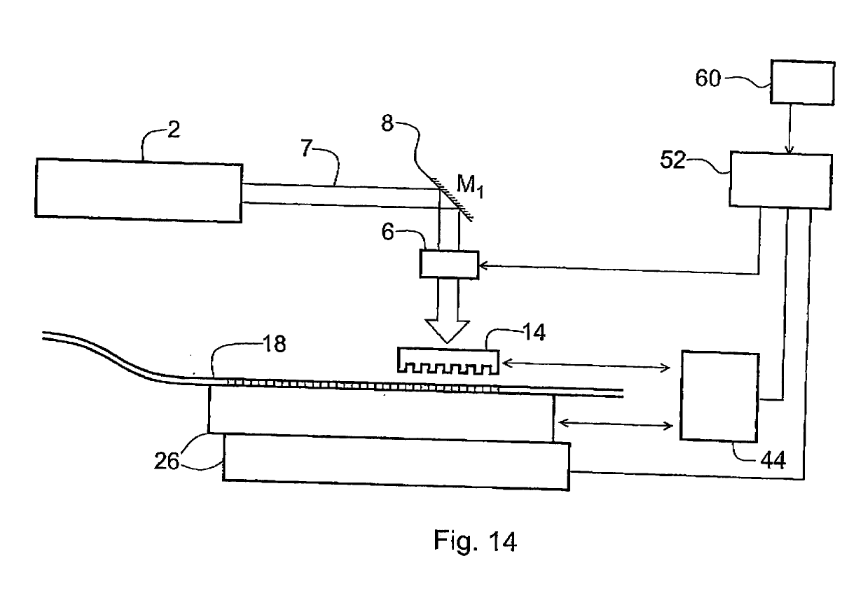

An apparatus for implementing the grating apodisation method is now described with reference to FIGS. 14 to 16.

FIG. 14 is a basic schematic diagram of a grating fabrication apparatus. A laser 2 supplies a beam 7 to a phase mask 14 via a mirror (M1) 8 and an acousto-optic modulator (AOM) 6 to expose a photosensitive waveguide in the form of an optical fibre 18. The fibre 18 is mounted on a translation stage 26 which is used to move the fibre 18 relative to the phase mask 14 under control of a control computer 60 control being implemented through a decision logic unit 52 and an interferometer 44 that is used to provide position measurements from the moving part of the translation stage.

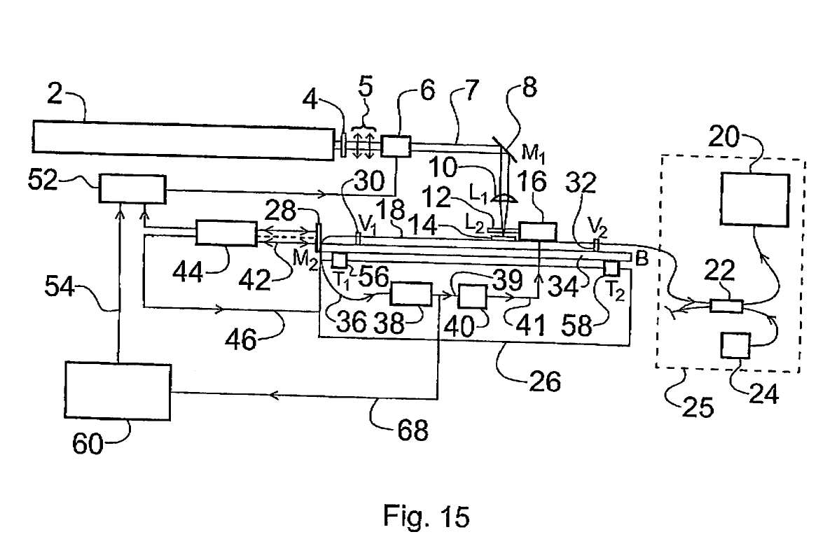

FIG. 15 is a more detailed diagram of the grating fabrication apparatus of FIG. 14. The interferometer is shown arranged to the left rather than the right of the translation stage, otherwise the two figures are directly relatable, with like reference numerals being used for corresponding components. As in FIG. 14, FIG. 15 illustrates a laser 2 supplying a beam 7 to a phase mask 14 to expose a photosensitive waveguide in the form of an optical fibre 18. The laser used is a continuous wave (CW) laser producing a beam having a power of up to 100 mW at a lasing wavelength of 244 nm, i.e. in the ultra-violet (UV) region. Placed in the beam path of the laser 2 there are in turn an interlock 4 and an acousto-optic modulator (AOM) 6. The laser beam is in a polarised state as indicated by arrows 5. After traversing these components, the beam 7 is deflected through 90 degrees by a mirror (M1) 8, through a focusing lens (L1) 10, a further lens (L2) 12 and the phase mask 14, thereby to image a periodic intensity pattern onto a section of the optical fibre 18. The phase mask 14 is positioned remote from the optical fibre 18, rather than in contact. A piezoelectric positioning device (PZT) 16 is provided for adjusting the position of the lens 12 to ensure good alignment between the beam 7 and the optical fibre 18. The position adjustment may be in the form of a dither (i.e. periodic spatial oscillation) having a frequency selected to be small in comparison to the rate at which fringes traverse the exposure region (which is typically in the order of i). A value of 20 Hz is typical for the dither frequency.

The optical fibre 18 is securely held on a bar (B) 34 in first and second V-grooves (V1 & V2) 30 and 32. At one end of the bar 34 there is mounted a mirror (M2) 28 which defines a measurement arm 42 of an interferometer 44 that is used to provide absolute position measurements of the bar 34 which is movably mounted on a linear translation stage 26. Translation mounts T1 & T2) 56 and 58 mount the bar 34 to the translation stage 26. The translation stage used provided a travel of about 105 cm (42 inches). The interferometer 44 used was a double-pass He—Ne interferometer. A position feed-back connection 46 provides a feed-back signal from the interferometer 44 to the linear translation stage 26 to ensure absolute positioning accuracy. A further connection 48 connects au output of the interferometer 44 to a decision logic unit 52. The decision logic unit 52 receives a further input from a connection 54 which links the decision logic unit 52 to an output of a control computer (PC) 60. The control computer 60 stores a set of pre-calculated beam modulation positions which define the structure of the sting to be fabricated. The set of beam modulation positions may define an aperiodic structure (e.g. a chirped grating) or a periodic structure (e.g. a grating of a single period). The connection 54 relays a signal from the control computer 60 that conveys calculated beam modulation positions to the decision logic 52. The decision logic 52 controls the AOM 6 trough a connection 50 and based on the inputs from connections 48 and 54. Namely, the state of the AOM 6 is switched by the decision logic 52 when the measured position received from the interferometer 48 corresponds to the modulation position received from the control computer 60.

One end of the fibre 18 is connected to some general diagnostics 25 comprising an optical spectrum analyser (OSA) 20, a 50:50 beam splitter 22 and a broadband optical source 24 which are connected as shown in FIG. 15.

The.other end 36 of the fibre 18 is connected to a photo-detector 38 for measuring fluorescence induced in the fibre 18 by the light beam 7. In a specific example, the detector 38 measures fluorescence from an emission at 400 nm. The detector 38 has an output connected via connection 39 to a tracking circuit for conveying a fluorescence signal to the tracking circuit 40. Responsive to the fluorescence signal, the tracking circuit 40 outputs a dither control signal through a connection 41 to the PZT 16 that provides the above-described dithering.

The apparatus is farther provided with an additional control connection 68 which is used to supply the fluorescence signal from the detector 38 to the control computer 60. This can be used to control (with or without feedback) registry between the phase mask and portions of the grating already written.

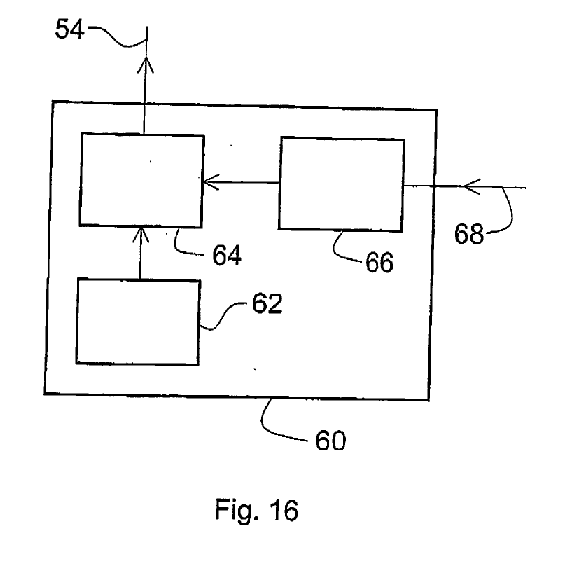

FIG. 16 shows internal structure of the control computer 60. The set of pre-calculated beam modulation positions defining the structure of the grating to be fabricated, including the grating structure in the apodisation regions, are stored in a storage device 62. A driver unit 64 is connected to transmit drive signals on connection 54 to the decision logic unit 52 which in turn controls the exposures via AOM 6. The driver unit is thus arranged to generate exposures of the interference pattern onto the photosensitive material at positions defined by the linear translation stage 26. A feedback control unit 66 is arranged to receive the fluorescence signal so that registry with existing portions of the grating can be maintained. This feedback facility is optional. In other words feedback control unit 66 and connection 68 could be dispensed with. In addition, it will be understood that all the components of the apparatus relating to measurement of fluorescence only have functions as either part of such a feedback control, non-feedback control, or as diagnostics. Accordingly, these components could all be dispensed with in a simpler alternative embodiment.

The control computer 60 is operable to write the desired apodisation profile for a grating by generating a first set of N exposures, where N is an integer equal to or greater than 2, separated by an integer multiple of the fringe period, and a second set of N exposures separated by the integer multiple of the fringe period and offset from the first set of N exposures by a dephasing distance equal to a fraction of the fringe period.

In the case of the fist embodiment in which N=2, and referring to FIG. 10B, the control computer is operable to implement the following sequence of events for writing an apodisation region:

(1) Set offset fraction 1/n to start value;

(2) Generate first exposure E1a;

(3) Move translation stage by one grating period [symbol] _{gr};

(4) Generate second exposure E1b;

(5) Move translation stage by offset fraction of (1-2/n) [symbol] _{gr};

(6) Generate third exposure E2a;

(7) Move translation stage by one grating period [symbol] _{gr};

(8) Generate fourth exposure E2b;

(9) Move translation stage by (1+2/n) [symbol] _{gr};

(10) Increment/decrement offset fraction 1/n; and

(11) Repeat (2) to (10).

It will be understood that when writing the start of a grating, dephasing will typically star from full dephasing (1/n=½) and then gradually progress through decrements to zero dephasing (1/n0) at which point writing of the in body of the grating will initiate. By coast, when wring the end of a grating, dephasing will typically start from zero dephasing (1/n=0) and gradually progress through increments to full dephasing (1/n=0) at which point the grating process will be complete.

It will be understood that the precise sequences specified above for the first embodiment is just one specific example. Many permutations of control sequence will generate the same result.

In the case of the second embodiment in which N=4, and referring to FIG. 10C, the control computer is operable to implement the following sequence of events to write an apodisation profile:

(1) Identify start of apodisation and set offset fraction 1/n to start value;

(2) Generate first exposures E1a;

(3) Move translation stage by one grating period [symbol] _{gr};

(4) Generate second exposure E1b;

(5) Move translation stage by one grating period [symbol] _{gr};

(6) Generate exposure E1c;

(7) Move translation stage by one grating period [symbol] _{gr};

(8) Generate fourth exposure E1d;

(9) Move translation stage by offset fraction of (I-2/n) [symbol] _{gr};

(10) Generate fifth exposure E2a;

(11) Move translation stage by one grating period [symbol] _{gr};

(12) Generate sib exposure E2b;

(13) Move translation stage by one grating period [symbol] _{gr};

(14) Generate seventh exposure E2c;

(15) Move translation stage by one grating period [symbol] _{gr};

(16) Generate eighth exposure E2d;

(17) Move translation stage by (1+2/n) [symbol] _{gr};

(18) Increment/decrement offset fraction 1/n; and

(19) Repeat (2) to (18).

The dephasing will typically be progressive as described in relation to the first embodiment. It will be understood tat the precise sequences specified above for the second embodiment is just one specific example. Many permuations of control sequence will generate the same result

7. Summary

In summary, in all previous studies of grating writing using phase mask technology and grating characterisation, it has been assumed that the imprinted refractive index variations are sinusoidal with a period ( [symbol] _{gr}) half that of the phase mask ( [symbol] ₚₘ), that is [symbol] _{gr}=0.5 [symbol] ₚₘ. It has been discovered that this assumption is not a good one. More specifically, it has been discovered through experiments that gratings written with the standard prior art phase mask technique show a substantial sub-harmonic component corresponding to the phase mask; period. Building from this discovery, it has been theoretically and experimentally shown that the sub-harmonic component automatically cancels out with prior art stroboscopic grating writing according to WO98/08120 when adjacent exposures are separated by one grating period, as is the case du a normal writing of the part of gratings. However, it has been theoretically and experimentally shown that the sub-harmonic component causes degradation of grating quality in the apodisation regions of gratings written according to WO98/08120 where the adjacent exposures are not separated by one grating period but rather offset by a different amount to cause apodisation. A new apodisation technique was then proposed and implemented to overcome this problem in which dephasing is introduced between pairs, or higher numbers, of exposures, instead of between individual exposures. This ensures that the sub-harmonic component is cancelled out during apodisation to improve the achievable dynamic range.

It will also be appreciated that the above-described method and apparatus can be applied to fabrication of chirped or unchirped gratings, not only in optical fibres, but also in any other suitable photosensitive material, such as suitable planar waveguide material.

Although the invention has been discussed in the context of generating interference patterns through a phase mask it will be understood that the invention could in principle be applied to remove zeroth order contributions from interference patterns generated interferometrically. This may provide a useful alternative to removing the zeroth order with a beam stop, which is a conventional solution that can be adopted with at least some interferometer arrangements.

1. A method of writing a grating into a photosensitive material using an interference pattern of hinge period [symbol] _{gr}, characterised in that an apodised part of the grating is written by:
exposing the photosensitive material with a first set of N exposures separated from each other by an odd integer multiple of the fringe period, wherein N is an even integer equal to or greater than 2; and
exposing the photosensitive material with a second set of N exposures separated from each other by an odd integer multiple of the fringe period and offset from the first set of N exposures by a fraction of the fringe period to introduce dephasing.

2. A method of writing a grating into a photosensitive material using an interference pattern of fringe period [symbol] _{gr}, comprising:
(a) wring an unapodised part of the grating by exposing the photosensitive material with a succession of exposures separated from each other by an odd number of fringe periods; and
(b) writing an apodised part of the grating by:
(i) exposing the photosensitive material with a first set of N exposures, where N is an even number, separated from each other by an odd number of fringe periods, the first set of N exposures having a positive phase offset +φ relative to the unapodised part of the grating; and
(ii) exposing the photosensitive material with a second set of N exposures separated from each other by an odd number of fringe periods, the second set of N exposures having a negative phase offset −φ relative to the unapodised part of the grating.

3. A method according to claim 1 or 2, where N=2 to provide pairs of exposures with the dephasing being introduced between the pairs.

4. A method according to claim 1 or 2, where NA to provide sets of four exposures with the dephasing being introduced between the sets of four exposures.

5. A method according to any one of the preceding claims, wherein a plurality of first and second sets of exposures are performed along the photosensitive material, the respective offsets being varied to provide a desired apodisation profile.

6. A method according to claim 5, wherein the respective offsets are varied along the photosensitive material from a small fraction towards a fraction of one-half at which maximum extinction is achieved.

7. A method according to any one of the preceding claims, wherein the interference pattern is generated with an interference pattern generator that is moved relative to the photosensitive material between the exposures.

8. A method according to claim 7, wherein the interference pattern generator comprises a phase mask.

9. A method according to claim 7, wherein the interference pattern generator comprises an interferometer.

10. A method according to any one of claims 1 to 9, wherein the photosensitive material is formed of an optical fibre.

11. A method according to any one of claims 1 to 9, wherein the photosensitive material is formed of a planar waveguide.

12. An apodised grating fabricated using the method of any one of the preceding claims.

13. An apparatus for writing a grating, comprising:
a positioner for moving a photosensitive material relative to an interference pattern generator;
a light source arranged to illuminate the interference pattern generator and generate an interference pattern of fringe period [symbol] _{gr} on the photosensitive material; and
a controller arranged to generate exposures of the interference pattern onto the photosensitive material at positions defined by the positioner,
characterised in that the controller is operable to write a desired apodisation profile by;
generating a first set of N exposures separated from each other by an odd integer multiple of the fringe period, wherein N is an even integer equal to or greater than 2; and
generating a second set of N exposures separated from each other by an odd integer multiple of the fringe period and offset from the first set of N exposures by a fraction of the fringe period to introduce dephasing.

14. An apparatus for writing a grating, comprising:
a positioner for moving a photosensitive material relative to an interference pattern generator;
a light source arranged to illuminate the interference pattern generator and generate an interference pattern of fringe period [symbol] _{gr} on the photosensitive material; and
a controller arranged to generate exposures of the interference pattern onto the photosensitive material at positions defined by the positioner,
characterised in that the controller is operable to:
(a) write an unapodised part of the grating by exposing the photosensitive material with a succession of exposures separated from each other by an odd number of fringe periods; and
(b) write an apodised part of the grating by:
(i) exposing the photosensitive material with a first set of N exposures, where N is an even number, separated from each other by an odd number of fringe periods, the first set of N exposures having a positive phase offset +φ relative to the unapodised part of the grating; and
(ii) exposing the photosensitive material with a second set of N exposures separated from each other by an odd number of fringe periods, the second set of N exposures having a negative phase offset −φ relative to the unapodised part of the grating.

15. An apparatus according to claim 13 or 14, wherein the controller is operable with N=2.

16. An apparatus according to claim 13 or 14, wherein the controller is operable with N=4.

17. An apparatus according to any one of claims 13 to 16, wherein the controller is operable to allow different values of N to be externally selected.

18. An apparatus according to any one of claims 13 to 17, wherein the controller is operable to perform a plurality of first and second sets of exposures along the photosensitive material, the respective offsets being varied to define the desired apodisation profile.

19. An apparatus according to claim 18, wherein the respective offsets are varied along the photosensitive material from a small faction towards a fraction of one-half at which maximum extinction is achieved.

20. An apparatus according to any one of claims 13 to 19, wherein the interference pattern generator comprises a phase mask.

21. An apparatus according to any one of claims 13 to 19, wherein the interference pattern generator comprises an interferometer.
